(19) United States
(12) Patent Application Publication
(10) Pub. No.: US 2011/0290429 A1
(43) Pub. Date: Dec. 1, 2011

(54) Control Device for folding/unfolding Window Shade

(76) Inventor: Li-Ming Cheng, Kaohsiung City (TW)

(21) Appl. No.: 12/789,860

(22) Filed: May 28, 2010

(51) Int. Cl. E06B 9/24

(52) U.S. Cl. 160/84.02

(57) ABSTRACT

A control device for folding/unfolding a window shade includes a casing rotatably receiving first and second driving wheels around which a pull cord and a tying cord are wound. The first driving wheel includes a first gear and a pressing member. The second driving wheel includes a second gear and an auxiliary gear. A clutch unit is located between the first and second driving wheels and includes a first end releasably engaged with the auxiliary gear on the second driving wheel and a second end abutting the pressing member. A transmission gear is slideably received in the casing. The pull cord is pullable to a desired extent to control the transmission gear to mesh with the first gear or both of the first and second gears, achieving folding or unfolding of the window shade.

### BACKGROUND OF THE INVENTION

1. Field of the Invention

The present invention relates to a control device for folding/unfolding a window shade and, more particularly, to a control device for folding/unfolding a window shade that is simple in structure and easy to operate.

2. Description of the Related Art

Window shades are generally mounted to windows, doorways, or passageways in buildings to shield the light, to provide privacy, and to provide a decoration. A wide variety of window shades including vertical shades, cloth shades, bead shades, etc has been proposed and generally includes a control device to fold/unfold the window shade, providing convenient use.

FIGS. 1-6 show a conventional control device 9 for a window shade. The control device 9 includes a casing 91, a first driving wheel 92, a second driving wheel 93, a slide 94, a clutch unit 95, and a transmission gear 96. The casing 91 includes a compartment 911 divided by a partitioning groove 912 into a first compartment section 911a and a second compartment section 911b respectively and rotatably receiving the first and second driving wheels 92 and 93. The first driving wheel 92 includes a first cord groove 921 and a first gear 922. The first cord groove 921 is formed in an outer periphery of the first driving wheel 92. A first pull cord 97 is wound and positioned in the first cord groove 921. An end of the first pull cord 97 is extended out of casing 91 through a hole 913 in a sidewall of the casing 91. The first gear 922 is fixed on a side of the first driving wheel 92.

The second driving wheel 93 includes a second cord groove 931, a second gear 932, and an auxiliary gear 933. The second cord groove 931 is formed in an outer periphery of the second driving wheel 93. A typing cord 98 is wound and positioned in the second cord groove 921. An end of the tying cord 98 is extended out of the casing 91 via a hole 914 in the sidewall of the casing 91 and connected to a shade. The second gear 932 is fixed on a side of the second driving wheel 931. The auxiliary gear 933 is fixed on the other side of the second driving wheel 93.

The slide 94 is slideably received in the partitioning groove 912. The clutch unit 95 is pivotably mounted to a bottom of the casing 91 and adjacent the second driving wheel 93. An end of a second pull cord 99 is extended through an end of the slide 94 and then engaged with an end of the clutch unit 95. The other end of the second pull cord 99 is extended out of the casing 91 via a hole 915 in the sidewall of the casing 91.

The casing 91 further includes a partitioning board 916 received in the compartment 911 and spaced from a top of the casing 91. The transmission gear 96 is received in a space defined between the top of the casing 91 and the partitioning board 916. The first and second gears 922 and 932 are respectively extended through two openings 9161 and 9162 of the partitioning board 916 into the space. The transmission gear 96 meshes with the first gear 922.

With reference to FIGS. 2 and 3, when it is desired to unfold the shade by operating the control device 9, a user pulls the second pull cord 99 to rotate the clutch unit 95 in a counterclockwise direction, disengaging the end of the clutch unit 95 from the auxiliary gear 933. In this state, the shade can move downward by gravity to drive the second driving wheel 93 in the counterclockwise direction, releasing the tying cord 98 from the second cord groove 931 and, thus, allowing downward movement of the shade for unfolding purposes.

With reference to FIGS. 2, 4, and 5, when it is desired to fold the shade, the user pulls the first pull cord 97 to drive the first driving wheel 91 to rotate in the clockwise direction, moving the transmission gear 96 to a position meshed with both of the first and second gears 922 and 932. When the first driving gear 922 continues to rotate in the clockwise direction, the second gear 932 is driven to rotate in the clockwise direction via the transmission gear 96. Thus, the tying cord 98 is moved in the winding direction and wound in the second cord groove 931, moving the shade upward for folding purposes.

However, the first and second pull cords 97 and 99 are liable to entangle with each other, as shown in FIG. 6. The use has to disentangle the first and second pull cords 97 and 99 before pulling one or both of them, leading to inconvenient use.

U.S. Pat. No. 6,223,802 entitled “CONTROL SYSTEM FOR COVERINGS FOR ARCHITECHTURAL OPENINGS” discloses a control device including a headrail receiving a main drive assembly, a clutch/brake assembly, and a brake mechanism. An end of the main drive assembly is connected to a lift system. A user can pull a pull tape to drive the main drive assembly, which, in turn, drives the lift system for winding a lift cord. The clutch/brake assembly includes a pinion gear meshed with a ring gear of the main drive assembly to restrain the rotating direction of the main drive assembly. The brake mechanism is rotatably received in the headrail and includes an end adjacent a brake disc of the clutch/brake assembly. The other end of the brake mechanism is extended out of the headrail.

When the other end of the brake mechanism is in an operative position, the end of the brake mechanism presses against a side of the brake disc such that the main drive assembly can only rotate in a single direction. Thus, a user can pull the pull tape to drive the main drive assembly and the lift system in a first direction, winding the lift cord around the lift system and, thus, folding the covering. On the other hand, when the other end of the brake mechanism is moved to the operative position, the end of the brake mechanism disengage from the brake disc such that the clutch/brake assembly no longer restrains the rotating direction of the main drive assembly, allowing rotating of the main drive assembly in the second direction. In this case, the lift system and the main drive assembly are driven to rotate in the second direction by gravity acting on the covering, releasing the lift cord and unfolding the covering.

Although the rotating direction of the main drive assembly can be restrained by the additional clutch/brake assembly to achieve folding/folding of the covering, the clutch/brake assembly must be operated through the brake mechanism, resulting in a complicated structure and inconvenient assemblage. Furthermore, the other end of the brake mechanism outside of the headrail and controlled by the pull tape is liable to be damaged or broken by improper pulling or impact by alien objects. Improvement in the above-two mentioned conventional control devices for folding/unfolding devices is required.

### SUMMARY OF THE INVENTION

An objective of the present invention is to provide a control device for folding/unfolding a window shade that controls vertical movement of the window shade by utilizing a single pull cord to avoid entanglement between multiple pull cords.

Another objective of the present invention is to provide a control device for folding/unfolding a window shade that controls engagement of a clutch unit by utilizing a single pull cord to enhance operational convenience and easiness.

A further objective of the present invention is to provide a control device for folding/unfolding a window shade that has fewer elements to enhance assembling convenience and to reduce manufacturing costs.

The present invention fulfills the above objectives by providing, in a preferred form, a control device for folding/unfolding a window shade includes a casing having a compartment, a guide slot, and first and second cord outlets in communication with the compartment. A first driving wheel includes a first body, a first gear, and a pressing member. The first body is rotatably received in the compartment and includes a first cord groove. A pull cord is releasably wound in the first cord groove and includes an end extending out of the casing via the first cord outlet. The first gear is fixed on a side of the first body. The pressing member is mounted around an outer periphery of the first body and includes an arm. A second driving wheel includes a second body, a second gear, and an auxiliary gear. The second body is rotatably received in the compartment and includes a second cord groove. A tying cord is releasably wound in the second cord groove. The tying cord includes an end extending out of the casing via the second cord outlet. The second gear and the auxiliary gear are respectively fixed on two opposite sides of the second body. A clutch unit is pivotably received in the compartment and located between the first and second driving wheels. The clutch unit includes a first end releasably engaged with the auxiliary gear. The clutch unit includes a second end abutting the arm of the pressing member. A transmission gear is received in the compartment and meshed with the first gear. The transmission gear is slideable along the guide slot to a position engaged with the first and second gears by pulling the pull cord.

The pull cord is pullable to a first extent to rotate the first driving wheel and to disengage the clutch unit from the second driving wheel, allowing rotation of the second driving wheel for unfolding the window shade while the transmission gear merely meshed with the first gear.

The pull cord is pullable to a second extent larger than the first extent to rotate the first driving wheel and to disengage the clutch unit from the second driving wheel and to move the transmission gear to the position engaged with the first and second gears, folding the window shade.

Thus, folding and unfolding of the window shade can be achieved by operating a single pull cord, providing a simplified structure.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows an exploded, perspective view of a conventional control device for folding/unfolding a window shade.

FIG. 2 shows a top view of the control device of FIG. 1.

FIG. 3 shows a top view similar to FIG. 2, illustrating release of a tying cord.

FIG. 4 shows a top view similar FIG. 2, illustrating movement of a transmission gear driven by a first gear to mesh with a second gear.

FIG. 5 shows a top view similar to FIG. 4, illustrating winding of a tying cord.

FIG. 6 is a top view illustrating entanglement of two pull cords of the control device of FIG. 1.

FIG. 7 shows a perspective view of a window shade utilizing a control device for folding/unfolding the window shade according to the preferred teachings of the present invention.

FIG. 8 shows an exploded, perspective view of the control device of FIG. 7.

FIG. 9 shows a bottom, exploded, perspective view of a first body and a return element of the control device of FIG. 7.

FIG. 10 shows a top view of the control device of FIG. 8 with a lid removed.

FIG. 11 shows a cross sectional view of the control device of FIG. 8 according to section line 11-11 of FIG. 10.

FIG. 12 shows a view similar to FIG. 11, illustrating release of a tying cord.

FIG. 13 is a partial, cross sectional view of the control device of FIG. 8, illustrating disengagement of a clutch unit from an auxiliary gear.

FIG. 14 shows a cross sectional view of the control device of FIG. 8 according to section line 14-14 of FIG. 12.

FIG. 15 shows a view similar to FIG. 11, illustrating engagement of a transmission gear with two gears.

FIG. 16 shows a view similar to FIG. 15, illustrating winding of the tying cord by a second driving wheel driven by a first driving wheel.

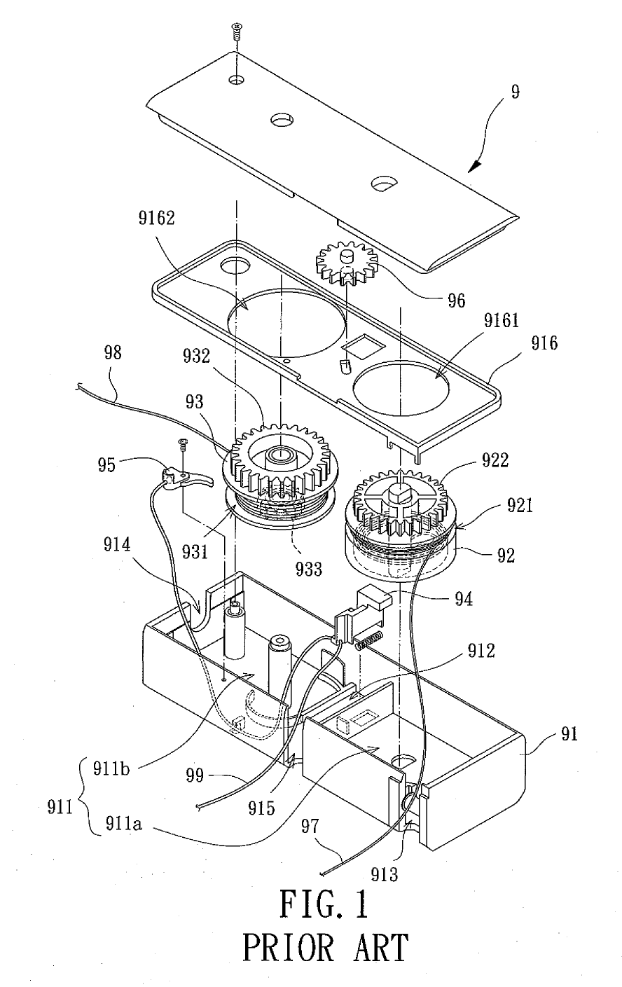

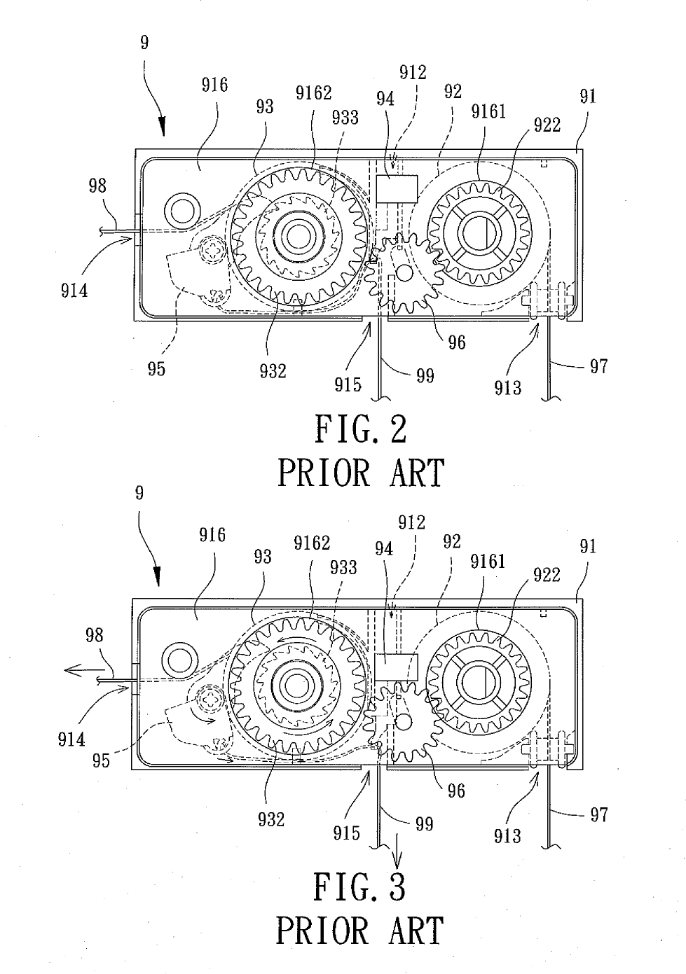

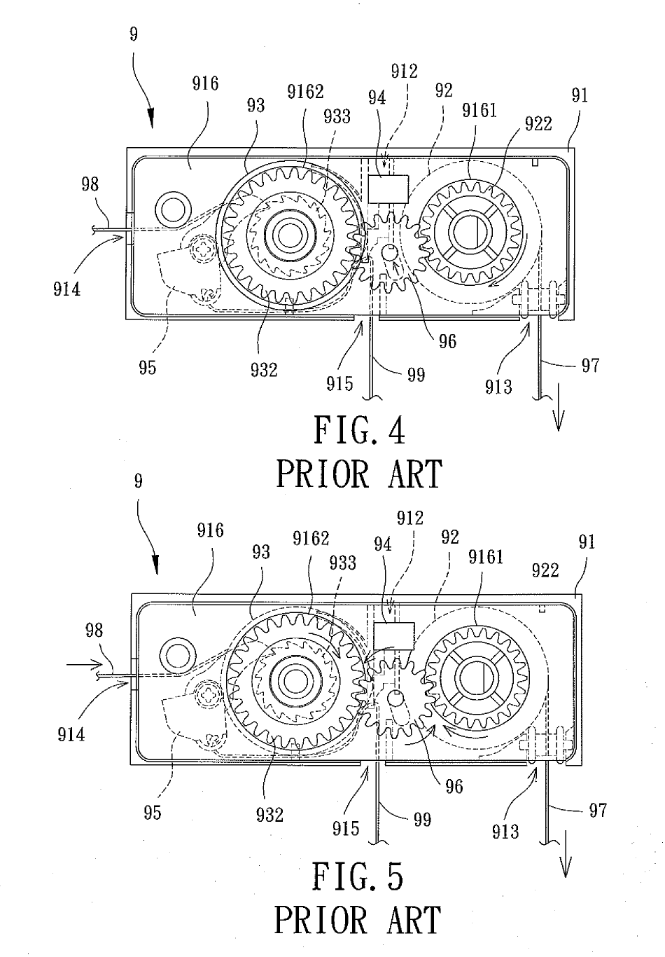

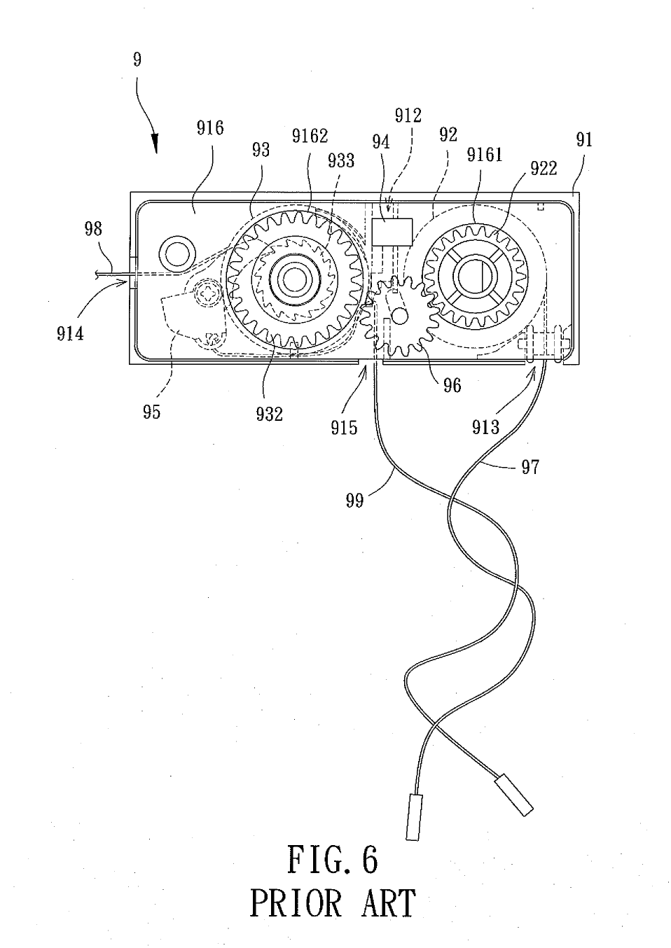

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “head”, “bottom”, “outer”, “side”, “end”, “portion”, “section”, “horizontal”, “vertical”, “annular”, “outward”, “spacing”, “clockwise”, “counterclockwise”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

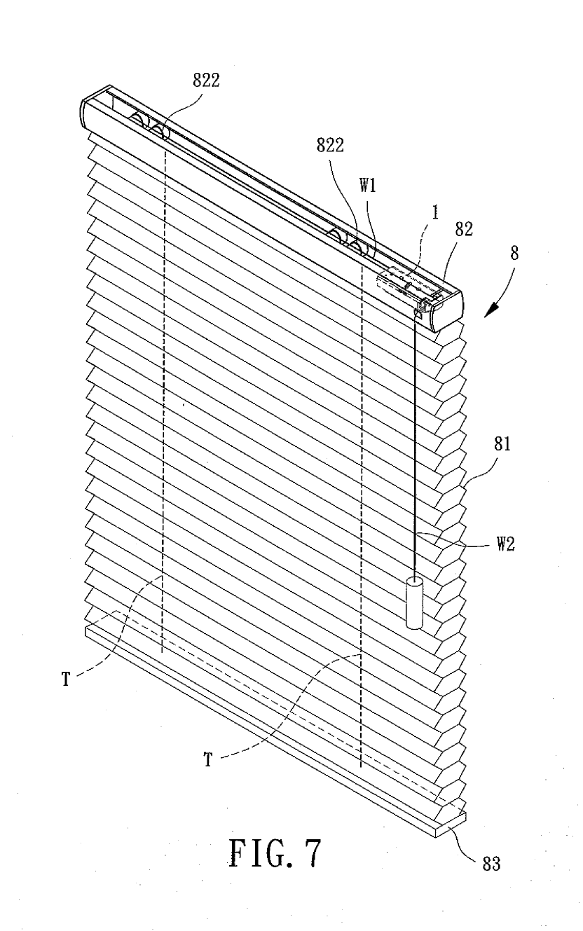

A control device according to the preferred teachings of the present invention can be utilized to control release and winding of a tying cord for folding/unfolding a window shade. The control device according to the preferred teachings of the present invention can be utilized with window shades of various types. FIG. 7 shows an example of the window shades in the form of a vertical shade 8. According to the preferred form shown, the vertical shade 8 includes a shade 81, a headrail 82 mounted to a top of the shade 81, and a bottom rail 83 mounted to a bottom of the shade 81. A cord T is arranged in an inverted U-shaped manner and includes a horizontal section received in the headrail 82 and two vertical sections extending through the shades 81 with two ends of the cord T anchored to bottom rail 83. The control device according to the preferred teachings of the present invention is received in the headrail 82 and includes a tying cord W1 having an end fixed to the horizontal section of the cord T. The shade 81 can be folded or unfolded by controlling the distance between the headrail 82 and bottom rail 83 through winding or release of the tying cord W1 that causes winding or release of the cord T from and around pulleys 822 rotatably received in the headrail 82. However, the control device according to the preferred teachings of the present invention can be utilized with window shades of other types.

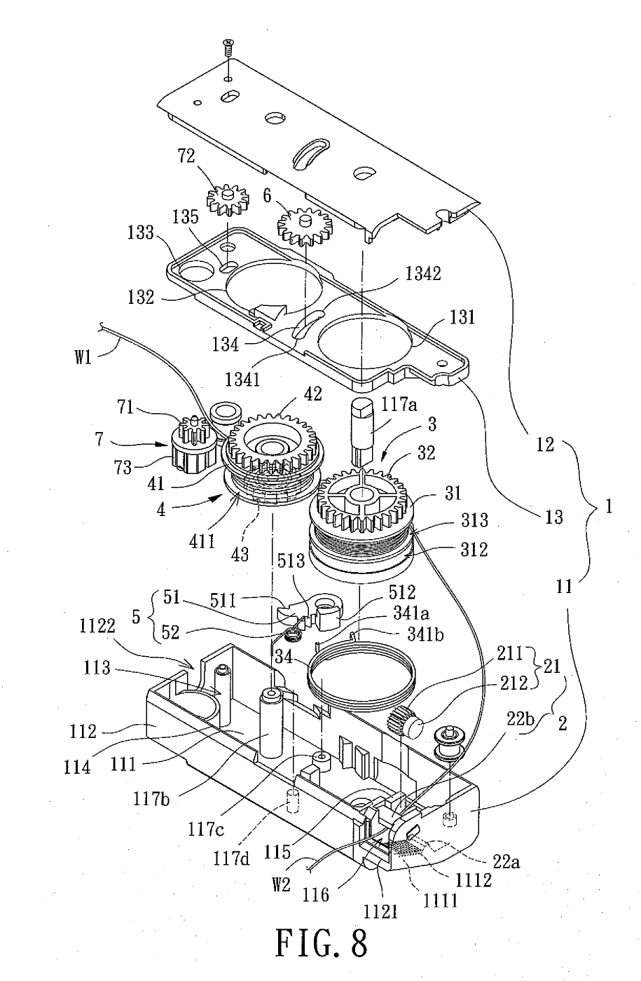

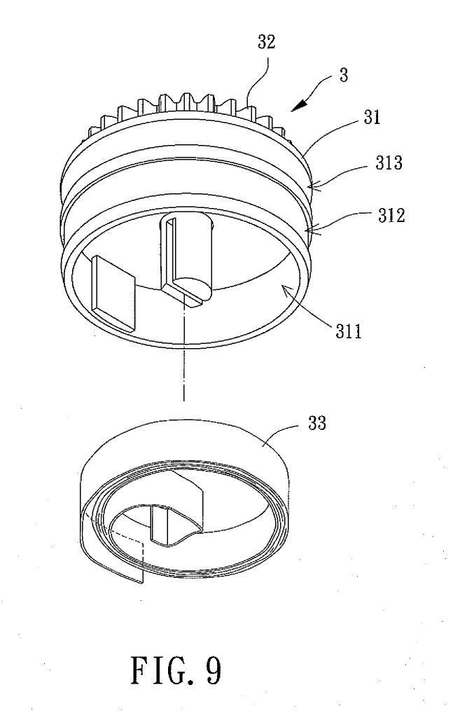

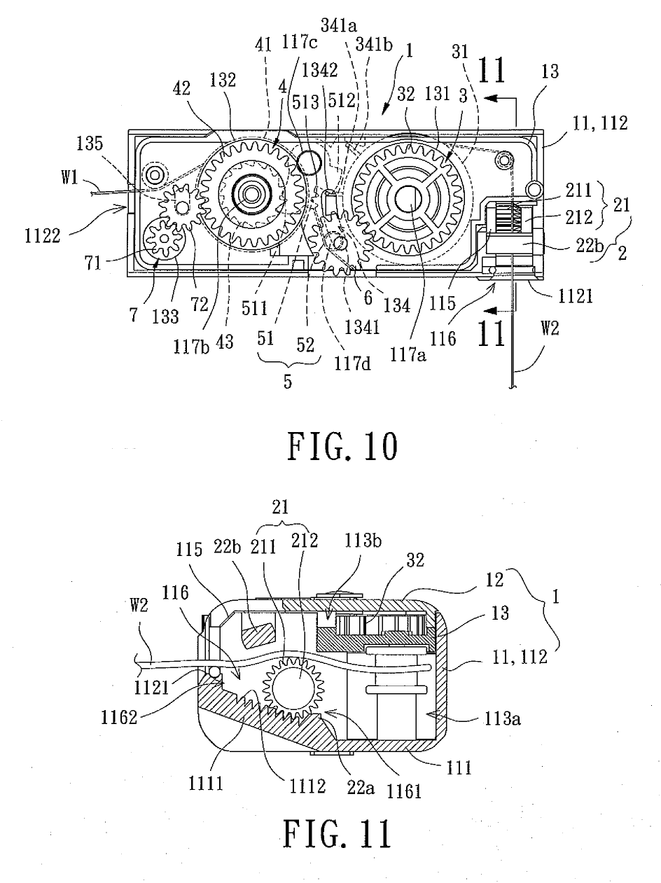

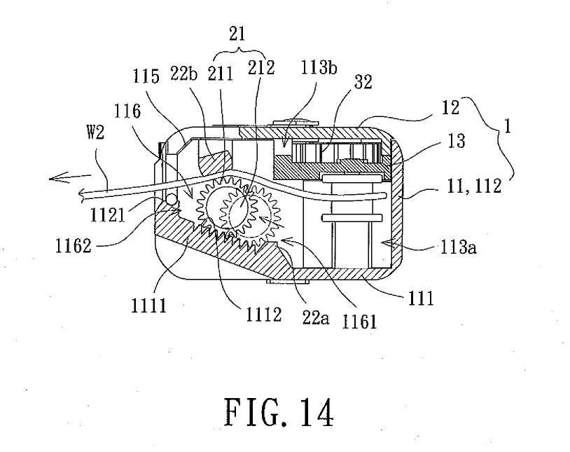

According to the preferred form shown in FIGS. 7-16, the control device according to the preferred teachings of the present invention includes a casing 1, a stop unit 2, a first driving wheel 3, a second driving wheel 4, a clutch unit 5, a transmission gear 6, and a speed reduction unit 7. The casing 1 is mounted in the headrail 82 and receives the stop unit 2, the first driving wheel 3, the second driving wheel 4, the clutch unit 5, the transmission gear 6, and the speed reduction unit 7. The stop unit 2 restrains travel of a pull cord W2. The first and second driving wheels 3 and 4 are respectively coupled to the pull cord W2 and the tying cord W1. Release and winding of the tying cord W1 can be controlled by pulling the pull cord W2. The clutch unit 5 is selectively engaged with the second driving wheel 4 to restrain the second driving wheel 4 to rotate in a single direction. The transmission gear 6 can be moved to connect the first and second driving wheels 3 and 4 so that the second driving wheel 4 can be driven to rotate by the first driving wheel 3 through transmission by the transmission gear 6. The speed reduction unit 7 is connected to the second driving wheel 4 to control the speed of the second driving wheel 4, avoiding excessive falling speed of the shade 81.

The casing 1 includes a base 11, a lid 12, and a partitioning board 13. The base 11 includes a bottom plate 111 and a sidewall 112 surrounding a perimeter of the bottom plate 111, defining a compartment 113 between the bottom plate 111 and the sidewall 112. The base 11 includes a mounting opening 114 in communication with the compartment 113. A stop wall 115 is formed on the base 11 to form a passageway 116 between the stop wall 115 and the sidewall 112. The passageway 116 includes a first end 1161 in communication with the compartment 113 and a second end 1162 in communication with a first cord outlet 1121 in the sidewall 112. The bottom plate 111 includes an inclined guide face 1111 in the passageway 116 and having a rack portion 1112. The inclined guide face 1111 inclines from the first end 1161 towards the second end 1162 of the passageway 116. A spacing between the first end 1161 and the lid 12 is larger than a spacing between the second end 1162 and the lid 12. The base 11 further includes a plurality of positioning bosses 117a, 117b, 117c, and 117d formed on a side of the bottom plate 111 facing the compartment 113 and extending from the bottom plate 111 towards the lid 12.

The lid 12 is mounted in the mounting opening 114 to prevent the elements in the compartment 113 from falling out of the casing 1 and to prevent dust or alien objects from entering the compartment 113.

The partitioning board 13 is detachably mounted in the compartment 113 and located between and parallel to the lid 12 and the bottom plate 111 of the base 11, so as to define a first compartment section 113a and a second compartment section 113b (see FIG. 11). The partitioning board 13 includes a plurality of through-holes and at least one guide slot. The through-holes and the guide slot extend through two opposite faces of the partitioning board 13 such that the first and second compartment sections 113a and 113b are in communication with each other via the through-holes and the guide slot. In the preferred form shown, the partitioning board 13 includes first, second, and third through-holes 131, 132, and 133 and first and second guide slots 134 and 135. The first through-hole 131 is adjacent to the passageway 116 of the base 11. The third through-hole 133 is adjacent to a second cord outlet 1122 in the sidewall 112. The second through-hole 132 is located between the first and third through-holes 131 and 133. The first guide slot 134 is located between the first and second through-holes 131 and 132. The second guide slot 135 is located between the second through-hole 132 and the third through-hole 133.

It can be appreciated that the first and second guide slots 134 and 135 do not have to be formed in the partitioning board 13. Alternatively, the first and second guide slots 134 and 135 can be formed in the lid 12.

The stop unit 2 includes a roller 21 and two stop bosses 22a and 22b. The roller 21 is received in the passageway 116 and rollable between the first and second ends 1161 and 1162 of the passageway 116. The roller 21 includes a toothed section 211 and a neck 212. Specifically, the toothed section 211 is formed on an outer periphery of an end of the roller 21 and meshes with the rack portion 1112 in the passageway 116. The neck 212 is formed on the other end of the roller 21 and contiguous to the toothed section 211. Preferably, the neck 212 has a smooth outer periphery. Furthermore, the neck 212 has an outer diameter smaller than that of the toothed section 211. The stop bosses 22a and 22b are formed or coupled inside the passageway 116. Specifically, the stop boss 22a is in the first end 1161 of the passageway 116, and the stop boss 22b is in the second end 1162 of the passageway 116. This avoids the roller 21 from falling out of the passageway 116 via either the first end 1161 or the second end 1162 and restrains movement of the roller 21 between the first and second ends 1161 and 1162.

The first driving wheel 3 includes a first body 31, a first gear 32, a return element 33, and a pressing member 34. The first body 31 is rotatably mounted to the positioning boss 117a on the base 11. The body 31 is cylindrical and includes a chamber 311, an annular groove 312, and a first cord groove 313. Specifically, the chamber 311 is formed in a side of the first body 31 adjacent the bottom plate 111. The return element 33 is coiled and received in the chamber 311 and has an end fixed to the positioning boss 117a. The annular groove 312 and the first cord groove 313 are defined in an outer periphery of the first body 31. The pressing member 34 is mounted in the annular groove 312. The pull cord W2 is wound in the first cord groove 313. The first gear 32 is fixed to the other side of the first body 31 facing the lid 12. The first gear 32 jointly rotates with the first body 31 when the first body 31 is driven to rotate. The return element 33 is in the form of a coiled spring plate for returning the rotated first body 31 to its initial position. The pressing member 34 is in the form of a torsion spring wound in the annular groove 312 and includes at least one arm. In the preferred form shown, the pressing member 34 includes two arms 341a and 341b. The arm 341a presses against the clutch unit 5 and is rotatable together with the first body 31 to drive the clutch unit 5 to rotate. The other arm 341b presses against the sidewall 112 of the base 11.

The second driving wheel 4 includes a second body 41, a second gear 42, and an auxiliary gear 43. The second body 41 is rotatably mounted to the positioning boss 117b. The second body 41 is cylindrical and includes a second cord groove 411 in an outer periphery thereof. The tying cord W1 is wound in the second cord groove 411. The second gear 42 is fixed to a side of the second body 41 facing the lid 12. The auxiliary gear 43 is fixed to the other side of the second body 41 facing the bottom plate 111. The second gear 42 and the auxiliary gear 43 jointly rotate with the second body 41 when the second body 41 is driven to rotate.

The first and second bodies 31 and 41 are received in the first compartment section 113a, and the first and second gears 32 and 42 are received in the second compartment section 113b after passing through the first and second through-holes 131 and 132.

The clutch unit 5 includes an engaging member 51 and a resilient return element 52. The engaging member 51 is pivotably mounted to the positioning boss 117c on the base 11. The engaging member 51 includes a catch 511, a driving portion 512, and an engagement portion 513. Specifically, the catch 511 is formed on an end of the engaging member 51 and releasably engaged with the auxiliary gear 43 of the second driving wheel 4 such that the second driving wheel 4 can only rotate in a single direction such as a counterclockwise direction. The driving portion 512 and the engagement portion 513 can be in the form of protrusions or grooves in an outer periphery of the engaging member 51. In the preferred form shown, the driving portion 512 is in the form of a protrusion, and the engagement protrusion 513 is in the form of a groove. The arm 341a of the pressing member 34 presses against the driving portion 512 such that the pressing member 34 can drive the engaging member 51 to rotate. In the preferred form shown, the resilient return element 52 is in the form of a torsion spring and mounted around the positioning boss 117d with a lever of the resilient return element 52 abutting the engagement portion 513 of the engaging member 51 and with the other lever of the resilient return element 52 abutting the sidewall 112. The resilient return element 52 allows returning of the rotated engaging member 51 to its initial position so that the engaging member 51 can engage the auxiliary gear 43.

The transmission gear 6 is received in the second compartment section 113b and includes an axle slideably received in the first guide slot 134. The transmission gear 6 only meshes with the first gear 32 when the axle of the transmission gear 6 is in a first end 1341 of the first guide slot 134. The transmission gear 6 meshes with the first and second gears 32 and 42 when the axle of the transmission gear 6 is in a second end 1342 of the first guide slot 134.

The speed reduction unit 7 is received in the first compartment section 113a and adjacent the second cord outlet 1122 of the sidewall 112. The speed reduction unit 7 includes a main gear 71 received in the second compartment section 113b after passing through the third-through hole 133. The speed reduction unit 7 further includes an idle gear 72 movable along the second guide slot 135 between a position meshed with the second gear 42 and another position meshed with the main gear 71 and the second gear 42. A speed reduction mechanism 73 is mounted to a side of the main gear 71. The speed of the second driving wheel 4 can be reduced by the speed reduction unit 7 while releasing the tying cord W1.

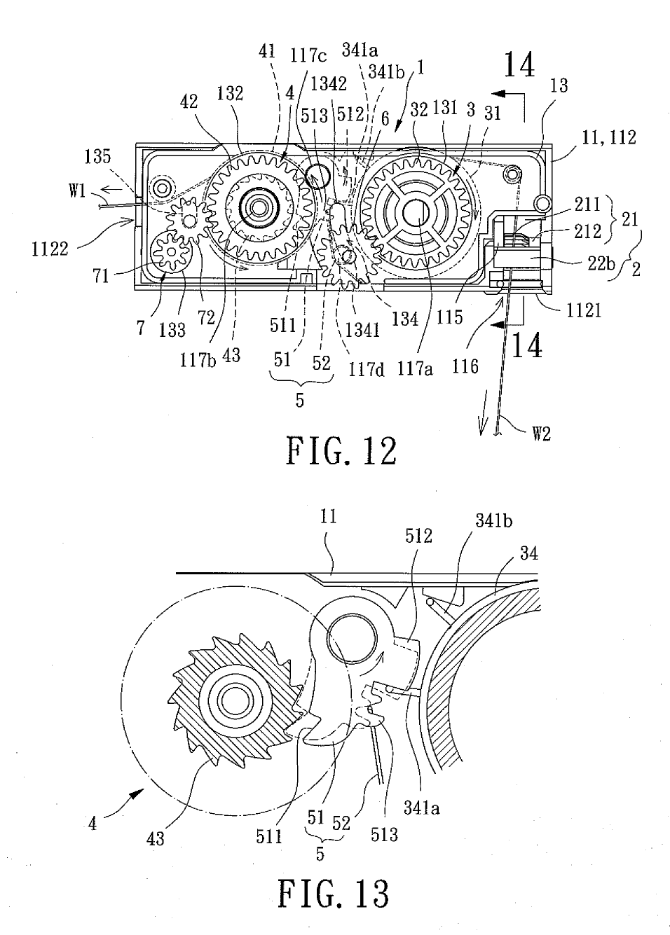

With reference to FIG. 7 and FIGS. 10-14, when moving the shade 83 from a folded state to an unfolded state by moving the bottom rail 81 downward, a user moves the pull cord W2 to a position aligned with and pressing against the toothed portion 211 of the roller 21 and then pulls the pull cord W2 outward of the casing 1. The roller 21 rolls along the inclined guide face 1111 from the first end 1161 of the passageway 116 to the second end 1162 of the passageway 116 and is stopped by the stop boss 22b. The pull cord W2 is clamped between the roller 21 and the stop boss 22b such that the user is unable to pull the pull cord W2 further. This allows the pull cord W2 to drive the first driving wheel 3 to undergo certain rotational movement in the clockwise direction insufficient to move the transmission gear 6 to the position meshed with the second gear 42. However, the certain rotational movement of the first driving wheel 3 is still sufficient to allow the arm 341 of the pressing member 34 to drive the engaging member 51 to rotate in the counterclockwise direction such that the catch 511 is disengaged from the auxiliary gear 43 (see FIG. 13).

In this state, since the second driving wheel 4 is no longer restrained by the catch 511 of the engaging member 51, the second driving wheel 4 is driven to rotate in the counterclockwise direction through the tying cord W1 by the gravity acting on the shade 81 and the bottom rail 83. Thus, the tying cord W1 in the second cord groove 411 is released via the second cord outlet 1122, and the shade 81 is folded accordingly.

The rack portion 1112 formed on the inclined guide face 1111 and the toothed portion 211 of the roller 21 avoid sliding of the roller 21 on the inclined guide face 1111 and, thus, avoid free rotation of the roller 21. The toothed portion 211 also assures rolling of the roller 21 on the inclined guide face 1111 by pulling the pull cord W2, providing stable operation and enhancing operational accuracy.

Furthermore, when the second gear 42 rotates in the counterclockwise direction, the idle gear 72 of the speed reduction unit 7 will be moved to the position meshed with the main gear 71 and the second gear 42. Since a side of the main gear 71 is coupled to the speed reduction mechanism 73, the speed of the second driving wheel 4 can be reduced through the idle gear 72 and the main gear 71, enhancing use safety and prolonging the service of life.

With reference to FIGS. 7, 10, 11, 15, and 16, when moving the shade 81 from the unfolded state to the folded state, the user moves the pull cord W2 to a position aligned with the neck 212 of the roller 21 and then pulls the pull cord W2 outward of the casing 1. Since the outer periphery of the neck 212 is smooth, the friction between the pull cord W2 and the neck 212 is insufficient to roll the roller 21 even though the pull cord W2 inadvertently comes in contact with the roller 21. Furthermore, since the outer diameter of the neck 212 is smaller than the toothed portion 212, a gap large enough to allow passage of the pull cord W2 exists between the neck 212 and the stop boss 22b even though the roller 21 is in the position pressing against the stop boss 22b. Thus, the pull cord W2 will not be restrained by the stop unit 2 when the pull cord W2 is aligned with the neck 212 and pulled by the user. This allows continuous pulling of the pull cord W2.

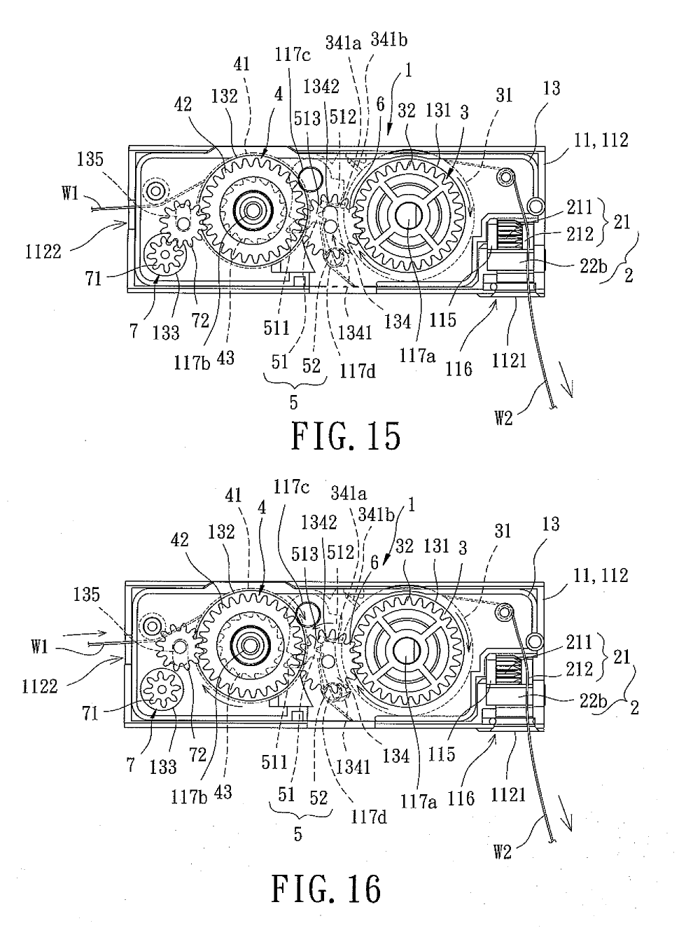

During continuous release of the pull cord W2 via the first cord outlet 1121, the first driving wheel 3 is driven to rotate in the clockwise direction such that the arm 341a of the pressing member 34 drives the engaging member 51 to rotate in the counterclockwise direction, disengaging the catch 511 from the auxiliary gear 43 (see FIG. 13). Furthermore, the transmission gear 6 is driven by the first gear 32 to move from the first end 1341 to the second end 1342 of the first guide slot 134 and, thus, engages with both of the first and second gears 32 and 42 (see FIG. 15).

Due to coupling of the transmission gear 6, the second driving wheel 4 will not rotate in the counterclockwise direction by the gravity acting on the shade 81 and the bottom rail 83, although the catch 51 of the engaging member 51 disengages from the auxiliary gear 43. Furthermore, clockwise rotation of the first gear 32 also drives the second gear 42 to rotate in the clockwise direction through transmission by the transmission gear 6, winding the tying cord W1 into the second cord groove 411. Responsive to continuous winding of the tying cord W1, the spacing between the bottom rail 83 and the headrail 82 is shortened, achieving folding of the shade 81.

The control device according to the preferred teachings of the present invention utilizes only one pull cord W2 to control the rotational travel of the first driving wheel 3 so as to control the engagement between the clutch unit 5 and the second driving wheel 4 and to control meshing of the transmission gear 6 with the first gear 32 or with the first and second gears 32 and 42, achieving control of release and winding of the tying cord W1 and, thus, achieving folding/unfolding of the shade 81. Compared to the conventional device, no pull cords are required for the clutch unit 5 of the control device according to the preferred teachings of the present invention. The structure of the control device according to the preferred teachings of the present invention is simplified while having fewer elements, enhancing operational convenience and accuracy.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A control device for folding/unfolding a window shade comprising:
a casing including a compartment, a guide slot, and first and second cord outlets in communication with the compartment;
a first driving wheel including a first body, a first gear, and a pressing member, with the first body rotatably received in the compartment and including a first cord groove, with a pull cord releasably wound in the first cord groove, with the pull cord including an end extending out of the casing via the first cord outlet, with the first gear fixed on a side of the first body, with the pressing member mounted on an outer periphery of the first body and including an arm;
a second driving wheel including a second body, a second gear, and an auxiliary gear, with the second body rotatably received in the compartment and including a second cord groove, with a tying cord releasably wound in the second cord groove, with the tying cord including an end extending out of the casing via the second cord outlet, with the second gear and the auxiliary gear respectively fixed on two opposite sides of the second body;
a clutch unit pivotably received in the compartment and located between the first and second driving wheels, with the clutch unit including a first end releasably engaged with the auxiliary gear, with the clutch unit including a second end abutting the arm of the pressing member; and
a transmission gear received in the compartment and meshed with the first gear, with the transmission gear slideable along the guide slot to a position engaged with the first and second gears by pulling the pull cord,
with the pull cord being pullable to a first extent for unfolding the window shade while the transmission gear merely meshed with the first gear,
with the pull cord being pullable to a second extent to move the transmission gear to the position engaged with the first and second gears, folding the window shade.

2. The control device as claimed in claim 1, with the casing including a base and a lid, with the base including a bottom plate and a sidewall surrounding a perimeter of the bottom plate, defining the compartment between the bottom plate and the sidewall, with the base including a mounting opening in which the lid is mounted.

3. The control device as claimed in claim 2, with the base including a stop wall, with a passageway formed between the stop wall and the sidewall, with the passageway including a first end in communication with the compartment and a second end in communication with the first cord outlet in the sidewall, with the pull cord extending through the passageway.

4. The control device as claimed in claim 3, with the bottom plate including an inclined guide face formed in the passageway, with the inclined guide face inclining from the first end towards the second end of the passageway, with a spacing between the first end of the passageway and the lid being larger than a spacing between the second end of the passageway and the lid.

5. The control device as claimed in claim 4, with the bottom plate including a rack portion formed in the inclined guide face.

6. The control device as claimed in claim 5, further comprising: a roller received in the passageway, with the roller being rollable between the first and second ends of the passageway.

7. The control device as claimed in claim 6, with the roller including first and second ends, with a toothed section formed on an outer periphery of the first end of the roller and meshed with the rack portion, with a neck formed on the second end of the roller and having an outer diameter smaller than that of the toothed section, with the neck having a smooth outer periphery.

8. The control device as claimed in claim 2, with the casing further including a partitioning board detachably mounted in the compartment and parallel to the lid and the bottom board, with the partitioning board dividing the compartment into a first compartment section and a second compartment section.

9. The control device as claimed in claim 8, with the guide slot defined in the partitioning board and located between the first and second driving wheels.

10. The control device as claimed in claim 3, with the first body further including an annular groove, with the annular groove and the first cord groove being defined in the outer periphery of the first body, with the pressing member received in the annular groove.

11. The control device as claimed in claim 10, with the pressing member being a torsion spring.

12. The control device as claimed in claim 2, with the clutch unit including an engaging member pivotably mounted to the base, with the engaging member including a catch releasably engaged with the auxiliary gear of the second driving wheel.

13. The control device as claimed in claim 12, with the engaging member further including a driving portion and an engagement portion, with the driving portion and the engagement portion being formed on an outer periphery of the engaging member, with the arm of the pressing member pressing against the driving portion.

14. The control device as claimed in claim 12, with the clutch unit further including a resilient return element pivotably mounted to the base, with the resilient return element including a first end abutting the engagement portion of the engaging member and a second end abutting the sidewall.

15. The control device as claimed in claim 1, with the first driving wheel being rotated to disengage the clutch unit from the second driving wheel and thus to allow rotation of the second driving wheel while the pull cord is pulled to the first extent.

16. The control device as claimed in claim 1, with the second extent being larger than the first extent, and the first driving wheel being rotated to disengage the clutch unit from the second driving wheel while the pull cord is pulled to the second extent.
